(19) United States
(12) Patent Application Publication
(10) Pub. No.: US 2016/0074804 A1
(43) Pub. Date: Mar. 17, 2016

(54) ABSORPTION MEDIUM, PROCESS FOR PRODUCING AN ABSORPTION MEDIUM, AND ALSO PROCESS AND APPARATUS FOR SEPARATING HYDROGEN SULFIDE FROM AN ACIDIC GAS

(71) Applicant: SIEMENS AKTIENGESELLSCHAFT, Munich (DE)

(72) Inventors: Kevin Brechtel, Uehlfeld (DE); Ralph Joh, Seligenstadt (DE); Markus Kinzl, Dietzenbach (DE); Hans Wolfgang Nickelfeld, Frankfurt (DE); Katrin Raake, Rödermark (DE); Matthias Renger, Frankfurt am Main (DE); Henning Schramm, Frankfurt am Main (DE)

(73) Assignee: SIEMENS AKTIENGESELLSCHAFT, Munich (DE)

(21) Appl. No.: 14/784,116

(22) PCT Filed: Feb. 18, 2014
(86) PCT No.: PCT/EP2014/053059

§ 371 Date: Oct. 13, 2015

(30) Foreign Application Priority Data
Apr. 15, 2013 (DE) 10 2013 206 721.6

(51) Int. Cl. B01D 53/14

(52) U.S. Cl. CPC B01D 53/1493; B01D 53/1468; B01D 53/1425; B01D 2257/304; B01D 2252/20494

(57) ABSTRACT

An absorption medium contains a dissolved amino acid salt and a dissolved metal. The absorption medium is brought into contact with the acidic gas in an absorber. In the absorber, the H₂S goes over from the gas phase into the liquid phase. In addition, carbon dioxide (CO₂) is likewise absorbed from the gas as a function of the contact time. The scrubbing solution is conveyed from the absorber into a regeneration tank. In the regeneration tank, the solution is treated with air, with oxygen (O₂)-enriched air or with pure O₂. As a result of the introduction of O₂ into the solution, the H₂S present in the solution is reacted at the dissolved metal catalyst. After the regeneration, possible solids are separated off and the regenerated scrubbing solution is recirculated to the absorber.

### CROSS REFERENCE TO RELATED APPLICATIONS

This application is the US National Stage of International Application No. PCT/EP2014/053059 filed Feb. 18, 2014, and claims the benefit thereof. The International Application claims the benefit of German Application No. DE 102013206721.6 filed Apr. 15, 2013. All of the applications are incorporated by reference herein in their entirety.

### FIELD OF INVENTION

The invention relates to an absorption medium for absorbing hydrogen sulfide (H₂S) from an acidic gas. The invention further relates to a process for separating H₂S from acidic gases. The invention additionally relates to an apparatus in which the process of the invention can be carried out.

### BACKGROUND OF INVENTION

Natural gas frequently does not occur in a quality which permits direct use, e.g. in a gas turbine, for pipeline transport or in a combined heating and power station (CHPS). For this reason, acidic gas streams having a quality which is too low are often not utilized. If the acidic gas is nevertheless to be utilized, H₂S has to be separated off from the gas since it can otherwise lead to irreparable damage due to corrosion on the combustion plant, gas turbine or pipeline. In addition, the parallel removal of CO₂ can be necessary in order to improve the quality of the gas.

Various processes for treating natural gas with physical and chemical scrubbing media or alternative separation techniques exist at present. The processes used hitherto for separating H₂S from a gas stream generally require after-treatment of the H₂S (e.g. in a Claus process). In the after-treatment, the gas is treated so that the purity necessary for further use is attained. The processes used hitherto also cannot be used usefully for small gas streams or are uneconomical.

Mostly aqueous solutions of amines, methanol or specific scrubbing media have been used hitherto. In these processes, the H₂S is separated off from the scrubbing solution by thermal means and/or by reducing the pressure and is passed to a further use. Here, the H₂S is usually converted into elemental sulfur by means of a Claus process. Processes in which the H₂S is absorbed in an aqueous solution and the dissolved H₂S is subsequently reacted catalytically are also known. Removal of CO₂ is not possible in these processes. Owing to the tremendous outlay for removal of H₂S, acidic gas reserves or acidic gas streams have hitherto frequently not been utilized or flared off unutilized.

Owing to the use of various scrubbing solutions in the removal of H₂S and CO₂ when employing a Claus plant for the conversion of H₂S, high specific costs are incurred, especially in the case of relatively small gas streams.

However, in view of the increasing shortage of raw materials, rising energy consumption and for reasons of environmental protection, the treatment and utilization of these gas streams is a promising possibility for efficient and low-emission generation of energy. The substantial challenge is the treatment of the acidic gases and especially the removal of H₂S and CO₂. Furthermore, inexpensive processes which make utilization of small gas streams possible have to be found.

### SUMMARY OF INVENTION

It is therefore an object of the invention to provide an absorption medium by means of which a utilizable gas can be produced inexpensively and in an environmentally friendly manner from acidic gas (sour gas), in particular natural gas, from accompanying gas from oil recovery (associated gas, flare gas) or from biogas by means of H₂S removal. Another object of the invention is to provide a process for producing such an absorption medium. A further object of the invention is to provide a process for separating H₂S from acidic gases. Furthermore, it is an object of the invention to provide an apparatus in which the process of the invention can be carried out.

The object of the invention directed at the provision of an absorption medium is achieved by the features of the independent claim.

Accordingly, an absorption medium for absorbing hydrogen sulfide from an acidic gas or gas mixture, in which absorption medium an amino acid salt and a metal salt are dissolved, wherein the proportion of the amino acid salt is in the range from 5 to 50% by weight and the proportion of the metal salt is less than 3% by weight, is provided.

The invention aims to improve an absorption medium which is a chemical scrubbing medium in such a way that it is able to absorb H₂S reversibly and to oxidize the dissolved H₂S in the solution directly to sulfur or sulfate ions. For this purpose, an amino acid salt is admixed with a metal salt. The required amounts of metal salt are here significantly below a concentration of 3% by weight. The concentration of the amino acid salt in the solution is in the range from 5 to 50% by weight.

The absorption medium is suitable for use for removing H₂S and CO₂ and also for converting the H₂S into sulfur or usable sulfur products (e.g. sulfates such as K₂SO₄). Due to the particular properties of the absorption medium, H₂S and CO₂ are taken up selectively, as a result of which the losses of hydrocarbon chains (CH₄) are minimized.

It is particularly advantageous that the regeneration of the absorption medium can be carried out by use of oxidation/stripping air without or with a significantly lower introduction of heating steam for CO₂ desorption compared to other processes. This is made possible by the use of an amino acid salt solution as absorption medium, which owing to its complexity and stability makes it possible to use air/oxygen as oxidant. Since the absorption medium operates at a low working temperature, the degradation of the solvent is greatly reduced. The process is thus suitable for small and large gas streams since the scrubbing solution has a high (chemical) storage capacity for H₂S and CO₂.

A concentration of amino acid salt in the absorption medium in the range from 15 to 35% by weight has been found to be particularly advantageous since it has been found that concentrations of less than 15% require a very large volume and concentrations above 35% lead to a viscous absorption medium. A particularly advantageous concentration of metal salt is in the range from 0.01 to 0.5% by weight. It has been found that even very small amounts are sufficient. As metal salt, advantage is given to using salts of the metals iron, manganese or copper. These metals ions are inexpensive to procure and are suitable as catalyst. All metal salts which can be oxidized and reduced, i.e. can be present in a plurality of oxidation states, are in principle suitable here.

To improve the solubility of the metal salt, a complexing agent (complex former) can be added to the absorption medium. This prevents precipitation of the metal ions as metal sulfides. The complexing agent in particular has a proportion in the range from 50 to 300% of the concentration of the metal ions. Advantage is given to using EDTA, citrate ions or chloride ions as complexing agents. All complexing agents which are able to keep the metal ions in solution are suitable in principle. Since there is a dependence between metal ion and complexing agent, these have to be matched to one another.

An object of the invention directed at the production of an absorption medium is achieved by the features of the independent claim directed to an absorption medium.

According to aspects of the invention, the absorption medium is produced by dissolving an amino acid salt and a metal salt in a solvent. The two substances can be dissolved in succession or simultaneously. The advantages according to the invention arise analogously from the advantages of the absorption medium.

An object of the invention directed at a process for absorbing hydrogen sulfide from an acidic gas is achieved by the features of the independent claim directed to the process.

A process having three process steps is provided. In the first process step, the acidic gas is brought into contact with a liquid absorption medium. As a result, hydrogen sulfide is absorbed from the gas phase into the liquid phase. In the second process step, the H₂S-containing liquid phase is treated with oxygen gas or with an oxygen-containing gas, resulting in precipitation of sulfur. In the third process step, sulfur is removed from the absorption medium so as to form a regenerated liquid phase.

Thus, H₂S is essentially separated off from the gas stream by means of an absorption medium and subsequently reacted by means of catalytic reaction, with a metal complex as catalyst being added in dissolved form to the absorption medium (scrubbing solution). In addition, usable potassium sulfate or alternatively elemental sulfur can be obtained from the H₂S by means of skillful process conditions.

Furthermore, the introduction of oxidation air required for the catalytic reaction of H₂S also brings about regeneration of the absorption medium in respect of carbon dioxide (CO₂) as component in the gas by reducing the partial pressure, so that thermal regeneration can be dispensed with. The CO₂ is thus stripped out.

The process steps can proceed in succession or simultaneously side-by-side.

The absorption medium contains dissolved amino acid salt and a dissolved metal (metal complex). The absorption medium is brought into contact with the acidic gas in an absorber. In the absorber, the H₂S goes over from the gas phase into the liquid phase. In addition, carbon dioxide (CO₂) is likewise absorbed from the gas as a function of the contact time. The scrubbing solution is conveyed from the absorber into a regeneration tank. In the regeneration tank, the solution is treated with air, with oxygen (O₂)-enriched air or with pure O₂. As a result of the introduction of O₂ into the solution, the H₂S present in the solution is reacted at the dissolved metal catalyst. After the regeneration, possible solids are separated off and the regenerated scrubbing solution is recirculated to the absorber.

### BRIEF DESCRIPTION OF THE DRAWINGS

FIG. 1 illustrates the reactions occurring, where Me is a metal ion:

### DETAILED DESCRIPTION OF INVENTION

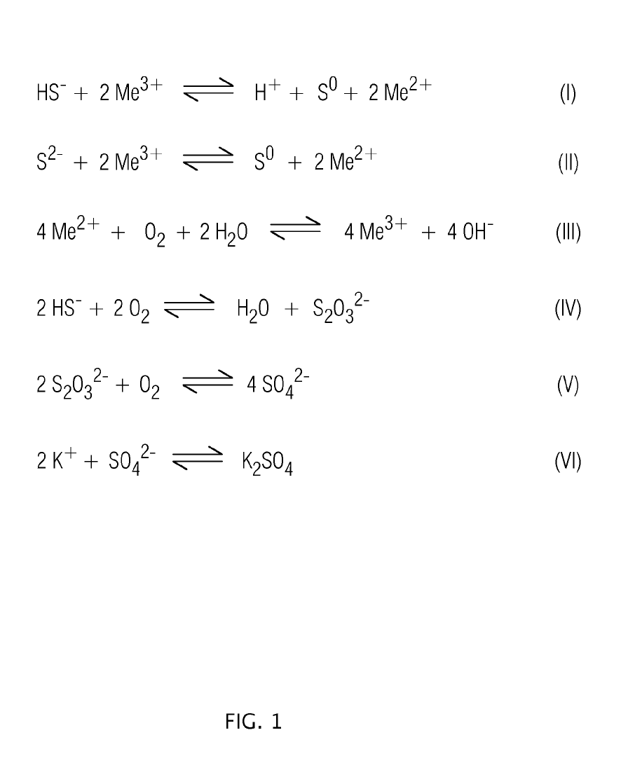

Essentially, the equations of FIG. 1 (I) to (III) proceed. Reactions (I) and (II) describe the oxidation of H₂S to elemental sulfur with simultaneous reduction of the metal ion. Equation (III) describes the oxidation of the reduced metal ion to its oxidized form. Equations (IV) and (V) represent secondary reactions, with the degree of conversion, the reaction rate and the reactions according to (IV) and (V) dependent on the pH and the redox potential. In general, it has been found that the redox potential and the pH can be used as indicator of the operational stability. However, it has to be noted that an excessively high redox potential, which in this case represents a measure of the amount of dissolved oxygen, is disadvantageous in the absorption.

Further advantages according to the invention of the process arise analogously from the advantages for the absorption medium.

Furthermore, it is particularly advantageous that, as a result of the introduction of air or oxygen, the CO₂ taken up in parallel in the absorption is stripped from the scrubbing solution and the scrubbing solution is thus likewise regenerated in respect of its CO₂ content.

If the process takes place at the same location where the gas is also used in a gas turbine, the waste air from the regeneration tank (oxidation reactor), which contains air and CO₂, can be utilized as combustion air for the gas turbine, with the absolute air throughput and thus the power of the gas turbine increasing as a result of the proportion of CO₂.

In a particularly advantageous further development of the process, the sulfur formed or the solids formed are removed from the absorption medium by sedimentation or by means of a hydrocyclone. The advantage of hydrocyclones is that the particle size of the fraction which is separated off can be determined by the mode of operation of the hydrocyclone and this has substantial advantages in further treatment steps for the solid (e.g. washing). Furthermore, fine particles are circulated further with the scrubbing solution, so that their size can increase further and they act as seed crystals for the further precipitation of the substances, which in turn accelerates crystallization (and thus leads to a reduction in the vessel volume of the regenerator).

As an alternative, the sulfur formed or the solids formed can also be removed by filtration.

After the solids have been separated off, the scrubbing medium can be recirculated to the absorber and once again take up H₂S (and CO₂). Depending on the way the process is carried out, the absorption medium can be heated or cooled by means of heat exchangers before entering the appropriate parts of the plant.

An object of the invention directed at an apparatus is achieved by the features of the independent claim directed to the separation apparatus.

The separation apparatus for carrying out the process accordingly comprises an absorber and a regeneration tank which are connected to one another via a line for passage of an absorption medium. The absorber is in particular a packed column, a bubble column reactor or a spray scrubber.

The separation apparatus can advantageously be provided with a flash pot which is installed in the line between the absorber and the regeneration tank, so that dissolved hydrocarbons can be removed from the absorption medium by depressurization. The hydrocarbons can have dissolved in the absorption medium (scrubbing solution) in the event of increased absorber pressure.

Since H₂S and CO₂ which have already been separated off likewise go over into the gas phase during “flashing” of the scrubbing solution, the gas phase separated off in the flash pot is in particular conveyed via a return line back to the inlet of the absorber.

Owing to the ability to separate off H₂S and CO₂, the invention is thus also suitable for the treatment of biogas by removal of H₂s and CO₂ as purification step for introduction of biogas into the natural gas grid.

1. An absorption medium for absorbing hydrogen sulfide from an acidic gas or gas mixture, the absorption medium comprising,
an amino acid salt and a metal salt dissolved therein,
wherein a proportion of the amino acid salt is in the range from 5 to 50% by weight and a proportion of the metal salt is less than 3% by weight.

2. The absorption medium as claimed in claim 1,
wherein the proportion of the amino acid salt is in the range from 15 to 35% by weight.

3. The absorption medium as claimed in claim 1,
wherein the proportion of the metal salt is in the range from 0.01 to 0.5% by weight.

4. The absorption medium as claimed in claim 1, wherein the metal salt is the salt of the metal iron, manganese or copper.

5. The absorption medium as claimed in claim 1, further comprising
a complexing agent added to the absorption medium in order to improve the solubility of the metal salt.

6. The absorption medium as claimed in claim 5,
wherein the complexing agent makes up a proportion of the absorption medium of less than 1% by weight.

7. The absorption medium as claimed in claim 5,
wherein the complexing agent is EDTA, citrate ions or chloride ions.

8. A process for producing the absorption medium as claimed in claim 1, the process comprising
dissolving amino acid salt and metal salt in a solvent.

9. A process for absorbing hydrogen sulfide from an acid gas, the process comprising:
bringing the acidic gas into contact with a liquid absorption medium as claimed in claim 1 and thereby absorbing hydrogen sulfide (H₂S) from the gas phase into the liquid phase,
treating the H₂S-containing liquid phase with oxygen (O₂) gas or with an oxygen-containing gas and thereby precipitating sulfur (S),
removing sulfur (S) from the absorption medium and thereby regenerating the liquid phase.

10. The process as claimed in claim 9, further comprising
removing the sulfur formed or the solids formed from the absorption medium by sedimentation or by a hydrocyclone.

11. The process as claimed in claim 9, further comprising
removing the sulfur formed or the solids formed by filtration.

12. A separation apparatus for carrying out the process as claimed in claim 9, which comprises
an absorber and a regeneration tank which are connected to one another via a line for passage of an absorption medium,
adapted such that oxygen or an oxygen-containing gas is introduced into the regeneration tank.

13. The separation apparatus as claimed in claim 12,
wherein the absorber is a packed column, a bubble column reactor or a spray scrubber.

14. The separation apparatus as claimed in claim 12, further comprising
a flash pot arranged in the line between the absorber and the regeneration tank adapted so that dissolved hydrocarbons are removed from the absorption medium by depressurization.

15. The separation apparatus as claimed in claim 14, further comprising
a return line,
wherein the gas phase separated off in the flash pot is conveyed via the return line back to the inlet of the absorber.
